(19) United States
(12) Patent Application Publication
(10) Pub. No.: US 2010/0208177 A1
(43) Pub. Date: Aug. 19, 2010

(54) LAMINATED OPTICAL FILM, LIQUID CRYSTAL PANEL, AND LIQUID CRYSTAL DISPLAY APPARATUS

(75) Inventors: Kentarou Kobayashi, Osaka (JP); Ryoji Kinoshita, Osaka (JP); Junichi Inagaki, Osaka (JP); Mitsuhiro Kibata, Osaka (JP); Yoshiki Maeda, Osaka (JP); Hironori Yaginuma, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/679,537

(22) PCT Filed: Sep. 12, 2008
(86) PCT No.: PCT/JP2008/066534

§ 371 Date: Mar. 23, 2010

(30) Foreign Application Priority Data
Oct. 23, 2007 (JP) 2007-275246

(51) Int. Cl. G02F 1/13363; G02F 1/13

(52) U.S. Cl. 349/102; 349/187

(57) ABSTRACT

The present invention provides a laminated optical film capable of contributing to thinning of each of a liquid crystal panel and a liquid crystal display apparatus and of simplifying its manufacturing steps, and a method of manufacturing the laminated optical film. The laminated optical film is used in a liquid crystal display apparatus and arranged on a viewer side of a liquid crystal cell. The laminated optical film includes: a polarizer; and a retardation layer which is arranged on one side of the polarizer, has a refractive index ellipsoid showing a relationship of nx>ny=nz, and has an in-plane retardation value Re[590] of 90 to 190 nm. An angle formed between an absorption axis of the polarizer and a slow axis of the retardation layer is 5 to 85°. The retardation layer is formed of a liquid crystal material, and the retardation layer is arranged to be closer to the viewer side than the polarizer is.

### TECHNICAL FIELD

The present invention relates to a laminated optical film, and more specifically, to a laminated optical film capable of contributing to thinning of each of a liquid crystal panel and a liquid crystal display apparatus.

### BACKGROUND ART

In recent years, portable equipment such as a cellular phone has been used as an image/motion picture-displaying body as well along with, for example, a start of the One seg broadcasting service. As a result, display methods employed in the portable equipment have been diversified. For example, there is exemplified portable equipment whose display screen can be rotated in its plane. When such display screen is viewed through a polarizing lens such as a polarizing sunglass, an image cannot be visually identified in some cases. In view of the foregoing, there is proposed a liquid crystal display apparatus provided with a transparent cover (λ/4 plate), which is a lens-shaped resin molded article, on the viewer side of its display screen (for example, Patent Document 1).

However, provision of a new member such as the transparent cover increases the thickness of the liquid crystal display apparatus. Meanwhile, the thinning of the liquid crystal display apparatus has been required. In addition, an increase in number of members causes an increase in number of manufacturing steps of the liquid crystal display apparatus (laminated optical film). As a result, foreign matters intrude between layers, and risks of causing a deficiency owing to the intruded foreign matters become higher.
Patent Document 1: JP 2005-148119 A

### DISCLOSURE OF THE INVENTION

### Problems to be solved by the Invention

The present invention has been made to solve the above-mentioned problems, and therefore an object of the present invention is to provide a laminated optical film capable of contributing to thinning of each of a liquid crystal panel and a liquid crystal display apparatus and of simplifying its manufacturing steps, and a method of manufacturing the laminated optical film.

### Means for solving the Problems

According to one aspect of the present invention, a laminated optical film is provided. The laminated optical film is used in a liquid crystal display apparatus and arranged on a viewer side of a liquid crystal cell. The laminated optical film includes: a polarizer; and a retardation layer which is arranged on one side of the polarizer, has a refractive index ellipsoid showing a relationship of nx>ny=nz, and has an in-plane retardation value Re[590] of 90 to 190 nm. An angle formed between an absorption axis of the polarizer and a slow axis of the retardation layer is 5 to 85°. The retardation layer is formed of a liquid crystal material, and the retardation layer is arranged to be closer to the viewer side than the polarizer is.

In one embodiment of the invention, the laminated optical film further includes a hard coat layer arranged on a side of the retardation layer opposite to the polarizer.

In another embodiment of the invention, the laminated optical film further includes a first protective film arranged between the polarizer and the retardation layer. In still another embodiment of the invention, the laminated optical film further includes a first protective film arranged on a side of the retardation layer opposite to the polarizer.

In still another embodiment of the invention, the angle formed between the absorption axis of the polarizer and the slow axis of the retardation layer is 40 to 50°.

In still another embodiment of the invention, the retardation layer includes a cured layer of the liquid crystal material. In still another embodiment of the invention, the retardation layer contains a UV screening agent.

According to another aspect of the present invention, a liquid crystal panel is provided. The liquid crystal panel includes the laminated optical film.

According to still another aspect of the present invention, a liquid crystal display is provided. The liquid crystal display includes the liquid crystal panel.

According to still another aspect of the present invention, a method of manufacturing a laminated optical film is provided. The laminated optical film is used in a liquid crystal display apparatus and arranged on a viewer side of a liquid crystal cell. The method includes subjecting a surface of a long-shaped substrate to an alignment treatment, applying an application liquid containing a liquid crystal material to the surface of the substrate to form a retardation layer which has a refractive index ellipsoid showing a relationship of nx>ny=nz and which has an in-plane retardation value Re[590] of 90 to 190 nm, and laminating a long-shaped polarizer having an absorption axis in its lengthwise direction and the retardation layer so that the lengthwise direction of the polarizer and a lengthwise direction of the retardation layer are brought into line with each other while conveying each of the polarizer and the retardation layer in the lengthwise direction. The lamination is performed so that an angle formed between a slow axis of the retardation layer and the absorption axis of the polarizer is 5 to 85°, and the retardation layer is arranged to be closer to the viewer side than the polarizer is.

### Effect of the Invention

According to the present invention, it is possible to provide the laminated optical film capable of contributing to the thinning of each of the liquid crystal panel and the liquid crystal display apparatus and of simplifying its manufacturing steps, and the method of manufacturing the laminated optical film.

### BRIEF DESCRIPTION OF THE DRAWINGS

FIG. 1 is a schematic sectional view of a laminated optical film according to a preferred embodiment of the present invention.

FIG. 2 is a schematic sectional view of a laminated optical film according to another preferred embodiment of the present invention.

FIG. 3 are schematic views each illustrating one step in an example of a method of manufacturing the laminated optical film of the present invention.

FIG. 4 is a schematic sectional view of a liquid crystal panel according to a preferred embodiment of the present invention.

FIG. 5 illustrates results of transmittance measurement for a retardation layer used in Example 1 of the present invention and for a retardation film used in Comparative Example 1.

FIG. 6 illustrates results of white luminance measurement for Example 1 of the present invention and Reference Example 1.

### DESCRIPTION OF SYMBOLS

10 laminated optical film
11 polarizer
12 retardation layer
13 hard coat layer
14 first protective film
15 second protective film
100 liquid crystal panel

### BEST MODE FOR CARRYING OUT THE INVENTION

Hereinafter, preferred embodiments of the present invention will be described. However, the present invention is not limited to these embodiments.

(Definitions of Terms and Symbols)

The definitions of terms and symbols used in the present specification are as follows.

(1) Refractive Index (nx, ny, nz)

“nx” denotes a refractive index in a direction (i.e., a slow axis direction) in which a refractive index in a plane is maximum, “ny” denotes a refractive index in a direction perpendicular to a slow axis in a plane, and “nz” denotes a refractive index in a thickness direction.

(2) In-Plane Retardation

An in-plane retardation (Re[λ]) refers to an in-plane retardation of a film at a wavelength of λ (nm) at 23° C. Re[λ] is obtained by Re[λ]=(nx−ny)×d, when d (nm) is a thickness of a film.

(3) Thickness Direction Retardation

A thickness direction retardation (Rth[λ]) refers to a retardation in a thickness direction of a film at a wavelength of λ (nm) at 23° C. Rth[λ] is obtained by Rth[λ]=(nx−nz)×d, when d (nm) is a thickness of a film.

(4) Nz Coefficient

An Nz coefficient is obtained by Nz=Rth[λ]/Re[λ].

A. Entire Structure of Laminated Optical Film

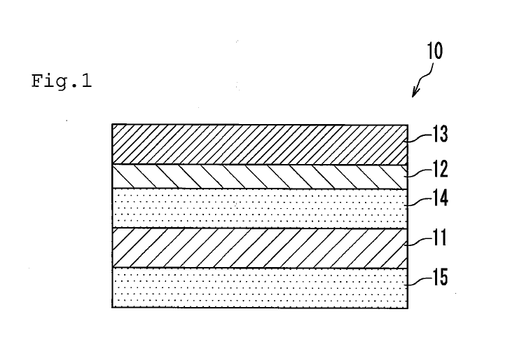

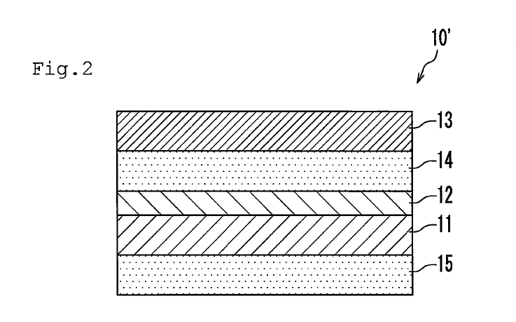

FIG. 1 is a schematic sectional view of a laminated optical film according to a preferred embodiment of the present invention. A laminated optical film 10 includes a polarizer 11 and a retardation layer 12 arranged on one side of the polarizer 11. The laminated optical film 10 further includes a hard coat layer 13 arranged on the side of the retardation layer 12 opposite to the polarizer 11, a first protective film 14 arranged between the polarizer 11 and the retardation layer 12, and a second protective film 15 arranged on the side of the polarizer 11 opposite to the retardation layer 12. FIG. 2 is a schematic sectional view of a laminated optical film according to another preferred embodiment of the present invention. A laminated optical film 10′ includes the polarizer 11 and the retardation layer 12 arranged on one side of the polarizer 11. The laminated optical film 10′ further includes the hard coat layer 13 and the first protective film 14 arranged on the side of the retardation layer 12 opposite to the polarizer 11, and the second protective film 15 arranged on the side of the polarizer 11 opposite to the retardation layer 12. In this embodiment, the first protective film 14 is arranged between the retardation layer 12 and the hard coat layer 13.

Although not illustrated, each of the laminated optical films 10 and 10′ may further include any other appropriate retardation layer. As a matter of practicality, any appropriate pressure-sensitive adhesive layer or adhesive layer is provided between members that form the laminated optical film of the present invention. Each layer (film) is described in each of sections A-1 to A-4.

The laminated optical film of the present invention is suitably used in a liquid crystal display apparatus. Then, the laminated optical film of the present invention is arranged on the viewer side of a liquid crystal cell. In addition, the retardation layer 12 is arranged so as to be closer to the viewer side than the polarizer 11 is. Specifically, the polarizer 11 is arranged on a liquid crystal cell side (the retardation layer 12 is on the viewer side). With such arrangement, polarized light emitted from the polarizer 11 can be appropriately transformed into elliptically polarized light. As a result, a liquid crystal display apparatus excellent invisibility can be provided even when its display screen is viewed through a polarizing lens such as a polarizing sunglass.

An angle α formed between the absorption axis of the polarizer 11 and the slow axis of the retardation layer 12 is 5 to 85°, preferably 30 to 60°, or more preferably 40 to 50°. When the angle is set to fall within such range, the polarized light emitted from the polarizer 11 can be more appropriately transformed into the elliptically polarized light.

A-1. Polarizer

The term “polarizer” used herein refers to a device capable of transforming natural light or polarized light into any polarized light. The polarizer preferably transforms natural light or polarized light into linearly polarized light. Such polarizer has a function of separating incident light into two polarization components perpendicular to each other, transmitting one polarization component, and absorbing, reflecting, and/or scattering the other polarization component.

Any appropriate polarizer may be employed as the above-mentioned polarizer 11. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dechlorinated product of a polyvinyl chloride-based film. Of those, a polarizer prepared by adsorbing a dichromatic substance such as iodine on a polyvinyl alcohol-based film and uniaxially stretching the film is particularly preferable because of high polarized dichromaticity.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times the length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required. Washing the polyvinyl alcohol-based film with water not only allows removal of contamination on a film surface or washes away an antiblocking agent, but also provides an effect of preventing nonuniformity such as uneven coloring by swelling of the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide or in a water bath. A thickness of the polarizer is typically about 1 to 80 μm.

A-2. Retardation Layer

The refractive index ellipsoid of the above-mentioned retardation layer 12 shows a relationship of nx>ny=nz. Here, “ny=nz” includes not only the case where ny and nz are strictly equal to each other but also the case where ny and nz are substantially equal to each other. Specifically, “ny=nz” refers to the case where an Nz coefficient (Rth[590]/Re[590]) is more than 0.9 and less than 1.1.

The above-mentioned retardation layer can function as the so-called λ/4 plate. The in-plane retardation value Re[590] of the retardation layer at a wavelength of 590 nm is 90 to 190 nm, preferably 110 to 170 nm, or more preferably 120 to 160 nm. When the in-plane retardation value is set to fall within such range, the polarized light emitted from the polarizer 11 can be more appropriately transformed into the elliptically polarized light.

The above-mentioned retardation layer is formed of a liquid crystal material. The use of the liquid crystal material can markedly enlarge a difference between nx and ny of the retardation layer to be obtained as compared to a non-liquid crystal material. As a result, the thickness of the retardation layer for obtaining a desired in-plane retardation value can be markedly reduced, and the reduction can contribute to thinning of each of a laminated optical film, a liquid crystal panel, and a liquid crystal display apparatus to be obtained. In addition, a roll-to-roll process can be performed in manufacturing the laminated optical film, and hence the number of manufacturing steps can be markedly decreased. Details about the foregoing are described later.

A liquid crystal phase of the above-mentioned liquid crystal material is preferably a nematic phase (nematic liquid crystal). The expression mechanism of liquid crystallinity of the liquid crystal material may be lyotropic or thermotropic. The alignment state of the liquid crystal material is preferably homogeneous alignment. As such liquid crystal material, for example, a liquid crystal polymer and a liquid crystal monomer may be used. Each of the liquid crystal polymer and the liquid crystal monomer may be used alone or in combination.

The above-mentioned retardation layer is preferably a cured layer of a liquid crystal material. Specifically, in the case where the liquid crystal material is a liquid crystalline monomer, it is preferred that the liquid crystal material is a polymerizable monomer and/or a cross-linking monomer. This is because the alignment state of the liquid crystalline monomer can be fixed by polymerizing or cross-linking the liquid crystalline monomer. The liquid crystalline monomers are aligned and then, for example, polymerized or cross-linked with each other, with the result that the above-mentioned alignment state can be fixed. Here, a polymer is formed by the polymerization and a three-dimensional network structure is formed by the cross-linking, and the resultants are non-liquid crystalline. Thus, the formed retardation layer, for example, is not transferred to a liquid crystal phase, a glass phase, or a crystal phase due to a change in temperature peculiar to a liquid crystalline compound. As a result, the retardation layer can become a layer which is remarkably excellent in stability and is not influenced by a change in temperature.

Any suitable liquid crystal monomers may be employed as the liquid crystal monomer. For example, there are used polymerizable mesogenic compounds and the like described in JP 2002-533742 A (WO 00/37585), EP 358208 (U.S. Pat. No. 5,211,877), EP 66137 (U.S. Pat. No. 4,388,453), WO 93/22397, EP 0261712, DE 19504224, DE 4408171, GB2280445, and the like. Specific examples of the polymerizable mesogenic compounds include: LC242 (trade name) available from BASF Aktiengesellschaft; E7 (trade name) available from Merck & Co., Inc.; and LC-Silicone-CC3767 (trade name) available from Wacker-Chemie GmbH.

For example, a nematic liquid crystal monomer is preferred as the liquid crystal monomer, and a specific example thereof includes a monomer represented by the below-indicated formula (1). The liquid crystal monomer may be used alone or in combination of two or more thereof.

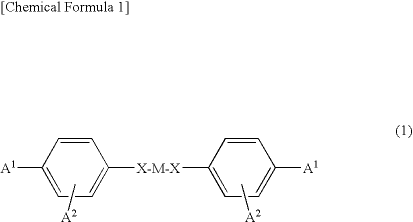

In the above formula (1), A¹ and A² each represent a polymerizable group, and may be the same or different from each other. One of A¹ and A² may represent hydrogen. Each X independently represents a single bond, —O—, —S—, —C═N—, —O—CO—, —CO—O—, —O—CO—O—, —CO—NR—, —NR—CO—, —NR—, —O—CO—NR—, —NR—CO-O—, —CH₂—O—, or —NR—CO—NR—. R represents H or an alkyl group having 1 to 4 carbon atoms. M represents a mesogen group.

In the above formula (1), Xs may be the same or different from each other, but are preferably the same.

Of monomers represented by the above formula (1), each A² is preferably arranged in an ortho position with respect to A¹.

A¹ and A² are preferably each independently represented by the below-indicated formula (2), and A¹ and A² preferably represent the same group.

Z—X-(Sp)ₙ (2)

In the above formula (2), Z represents a crosslinkable group, and X is the same as that defined in the above formula (1). Sp represents a spacer consisting of a substituted or unsubstituted linear or branched alkyl group having 1 to 30 carbon atoms. n represents 0 or 1. A carbon chain in Sp may be interrupted by oxygen in an ether functional group, sulfur in a thioether functional group, a non-adjacent imino group, an alkylimino group having 1 to 4 carbon atoms, or the like.

In the above formula (2), Z preferably represents any one of functional groups represented by the below-indicated formulae. In the below-indicated formulae, examples of R include a methyl group, an ethyl group, an n-propyl group, an i-propyl group, an n-butyl group, an i-butyl group, and a t-butyl group.

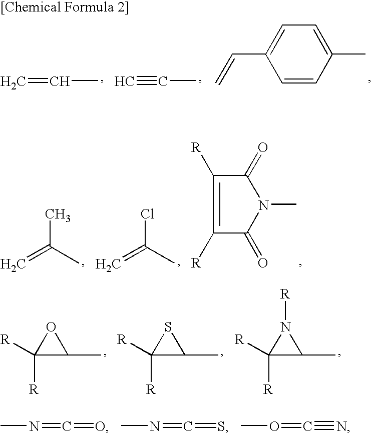

In the above formula (2), Sp preferably represents any one of structural units represented by the below-indicated formulae. In the below-indicated formulae, m preferably represents 1 to 3, and p preferably represents 1 to 12.

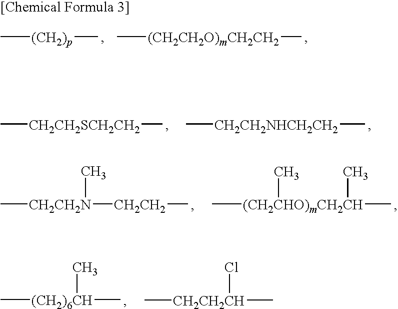

In the above formula (1), M is preferably represented by the below-indicated formula (3). In the below-indicated formula (3), X is the same as that defined in the above formula (1). Q represents a substituted or unsubstituted linear or branched alkylene group, or an aromatic hydrocarbon group, for example. Q may represent a substituted or unsubstituted linear or branched alkylene group having 1 to 12 carbon atoms, for example.

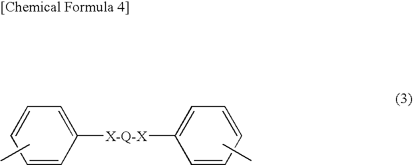

In the case where Q represents an aromatic hydrocarbon group, Q preferably represents any one of aromatic hydrocarbon groups represented by the below-indicated formulae or substituted analogues thereof.

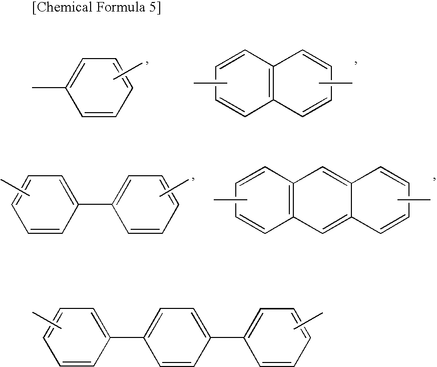

The substituted analogues of the aromatic hydrocarbon groups represented by the above formulae may each have 1 to 4 substituents per aromatic ring, or 1 to 2 substituents per aromatic ring or group. The substituents may be the same or different from each other. Examples of the substituents include: an alkyl group having 1 to 4 carbon atoms; a nitro group; a halogen group such as F, Cl, Br, or I; a phenyl group; and an alkoxy group having 1 to 4 carbon atoms.

Specific examples of the liquid crystal monomer include monomers represented by the following formulae (4) to (19).

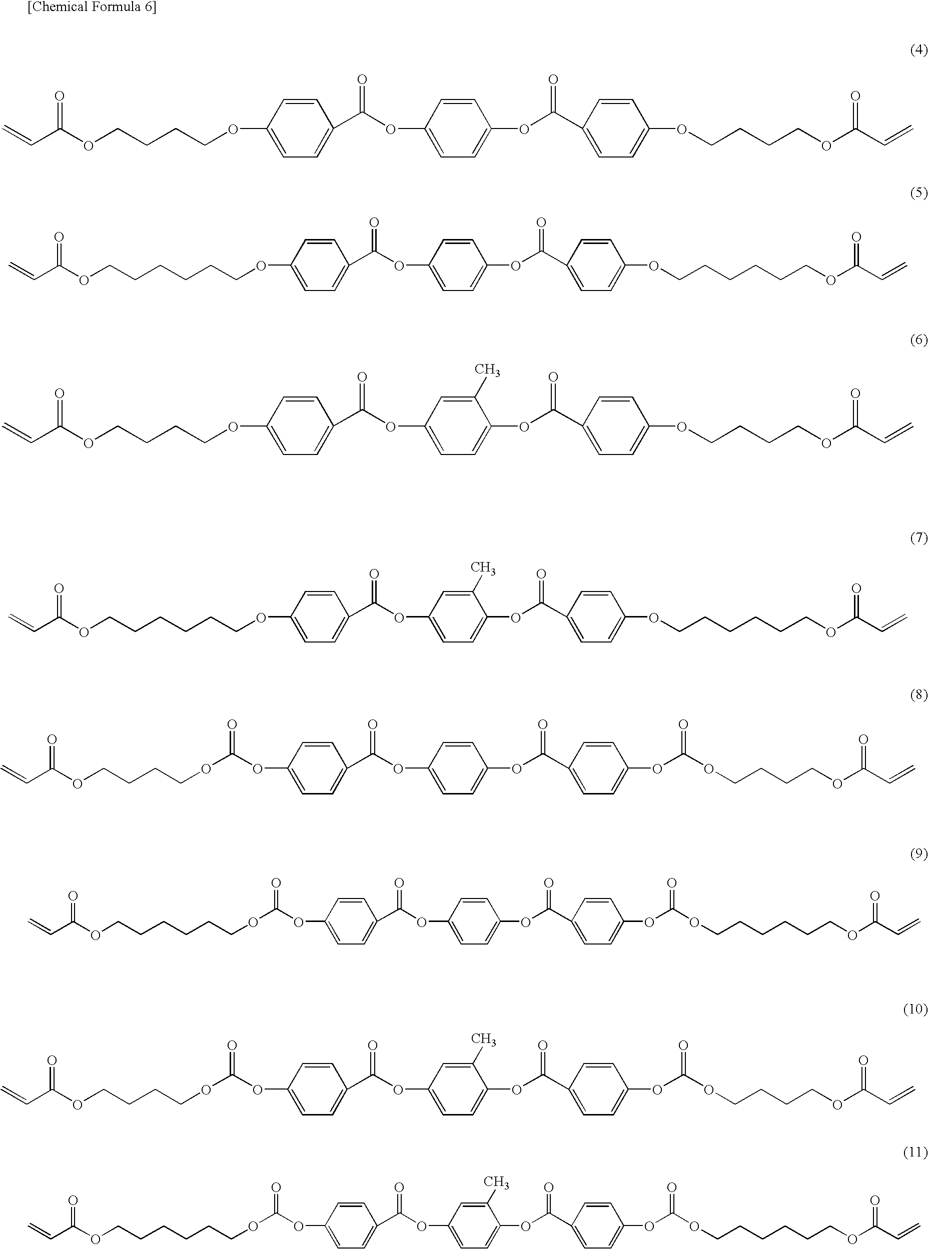

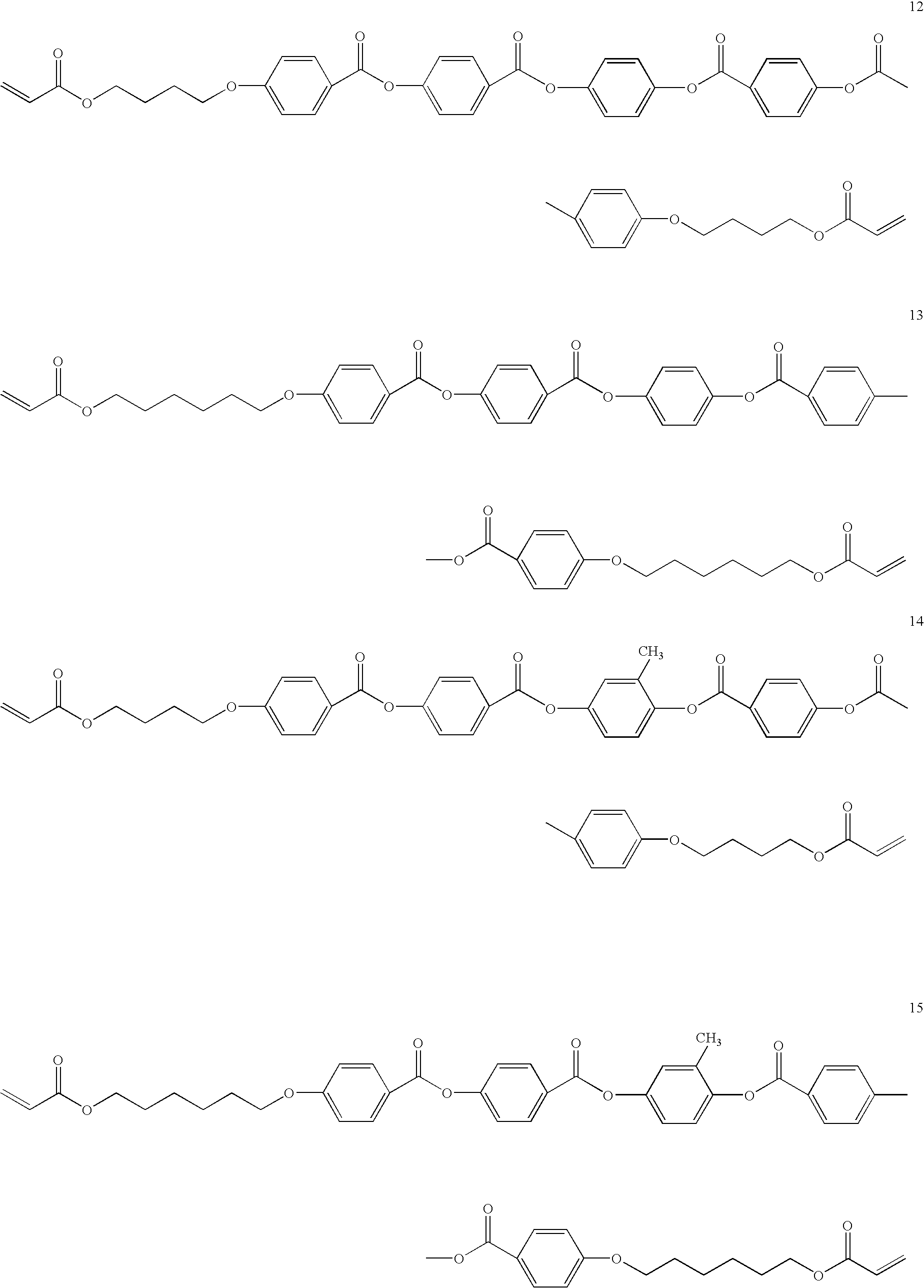

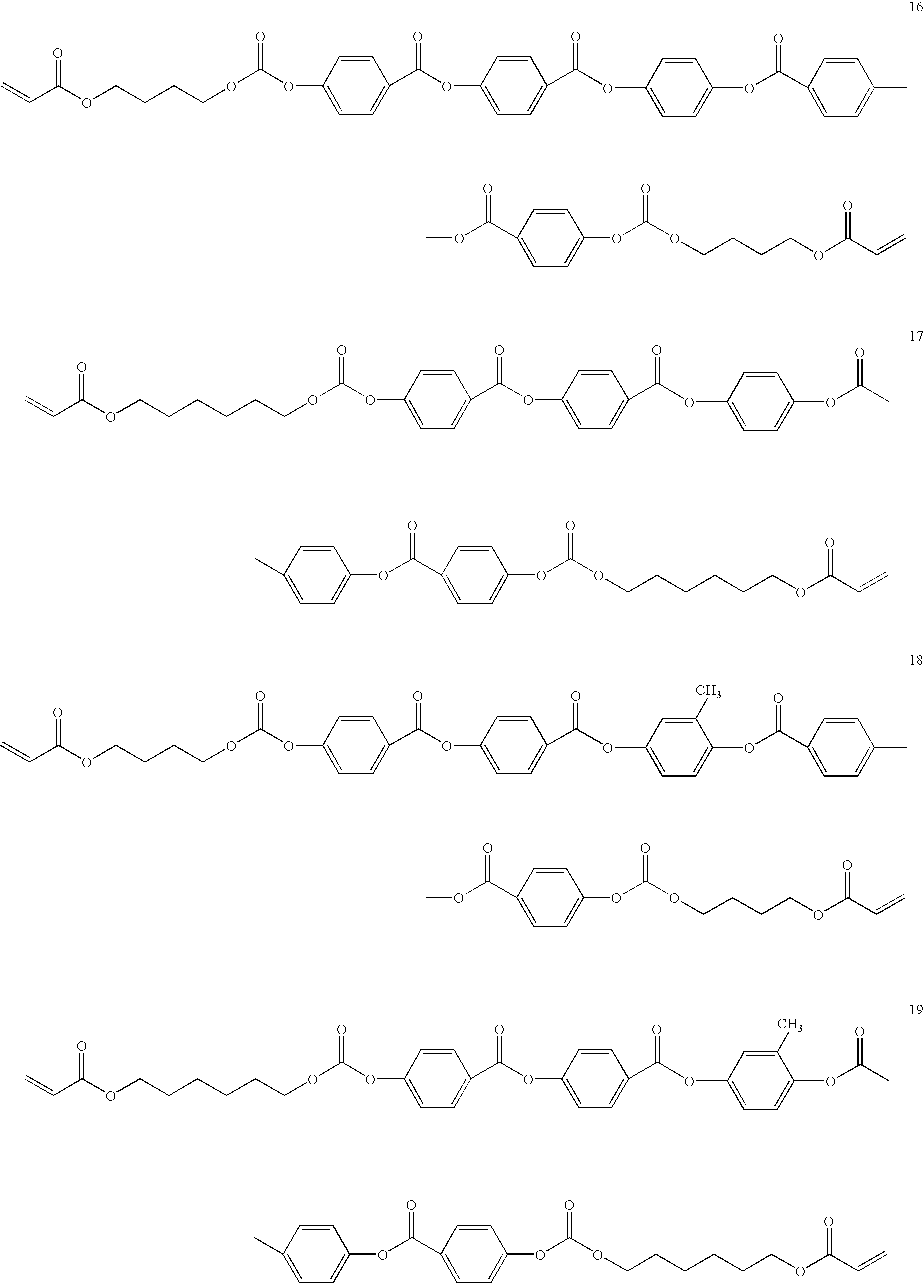

A temperature range in which the liquid crystal monomer exhibits liquid-crystallinity varies depending on the type of liquid crystal monomer. More specifically, the temperature range is preferably 40 to 120° C., more preferably 50 to 100° C., and most preferably 60 to 90° C.

The above-mentioned retardation layer preferably contains a UV screening agent. In the present invention, the retardation layer is arranged so as to be closer to the viewer side than the polarizer is. Therefore, the retardation layer is susceptible to UV. When the retardation layer contains the UV screening agent, an influence of UV can be suppressed. Specifically, the deterioration of the retardation layer can be suppressed, and the above-mentioned optical characteristics of the retardation layer can be favorably maintained. Further, an influence of UV on each member arranged on an inner side (liquid crystal cell side) than the retardation layer (such as the polarizer) can be suppressed.

Examples of the above-mentioned UV screening agent include an organic UV absorbing agent and an inorganic UV scattering agent. Examples of the organic UV absorbing agent include benzotriazole-, benzophenone-, and triazine-based UV absorbing agents. Examples of the inorganic UV scattering agent include titanium oxide, zinc oxide, and cerium oxide. They may be used alone or in combination. The organic UV absorbing agent is preferred. When the organic UV absorbing agent is used, the above-mentioned retardation layer can achieve a thickness, and can be excellent in transparency.

The thickness of the above-mentioned retardation layer may be set so as to function most appropriately as a λ/4 plate. In other words, the thickness maybe set so that the desired optical characteristics are obtained. The thickness of the retardation layer is preferably 0.5 to 10 μm, more preferably 0.5 to 8 μm, or particularly preferably 0.5 to 5 μm.

A-3. Hard Coat Layer

The above-mentioned hard coat layer 13 is preferably a cured layer of any appropriate UV curable resin. Examples of the UV curable resin include an acrylic resin, a silicone-based resin, a polyester-based resin, a urethane-based resin, an amide-based resin, and an epoxy-based resin. The hard coat layer may contain any appropriate additive as required. Representative examples of the additive include inorganic fine particles and/or organic fine particles. The incorporation of the fine particles can impart, for example, an appropriate refractive index.

The thickness of the above-mentioned hard coat layer may be set to any appropriate value. The thickness is preferably 50 μm or less, more preferably 1 to 50 μm, still more preferably 1 to 40 μm, or particularly preferably 1 to 30 μm. The hard coat layer has a pencil hardness of preferably 4H or more, or more preferably 5H to 8H.

The above-mentioned hard coat layer is typically used in the laminated optical film in a state of being brought into a laminate by a hard coat treatment on a base material in advance. Any appropriate resin film may be adopted as the base material. Representative examples of the resin film include a polyester-based resin, a cellulose-based resin, a polycarbonate-based resin, and a (meth)acrylic resin. The base material may function as the above-mentioned first protective film. It should be noted that the term “(meth)acrylic” used herein refers to acrylic and/or methacrylic.

A-4. Protective Films

Any appropriate film capable of functioning as a protective layer for the polarizer may be adopted as each of the first protective film 14 and the second protective film 15 described above. Specific examples of a material used as a main component of the film include transparent resins such as a cellulose-based resin such as triacetylcellulose (TAC), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, a (meth)acrylic resin, and an acetate-based resin. Another example thereof includes a thermosetting resin or a UV-curing resin such as a (meth)acrylic-based resin, an urethane-based resin, a (meth)acrylic urethane-based resin, an epoxy-based resin, or a silicone-based resin. Still another example thereof includes, for example, a glassy polymer such as a siloxane-based polymer. Further, a polymer film described in JP 2001-343529 A (WO 01/37007) may also be used. To be specific, the film can be formed of a resin composition containing a thermoplastic resin having a substituted or unsubstituted imide group on a side chain and a thermoplastic resin having a substituted or unsubstituted phenyl group and a nitrile group on a side chain. A specific example thereof includes a resin composition containing an alternate copolymer of isobutene and N-methylmaleimide and an acrylonitrile-styrene copolymer. The polymer film may be an extruded product of the resin composition, for example.

Glass transition temperature (Tg) of the (meth)acrylic resin is preferably 115° C. or higher, more preferably 120° C. or higher, still more preferably 125° C. or higher, and particularly preferably 130° C. or higher. This is because the (meth)acrylic resin having a glass transition temperature (Tg) of 115° C. or higher can be excellent in durability. The upper limit value of Tg of the (meth)acrylic resin is not particularly limited, but is preferably 170° C. or lower from the viewpoint of formability and the like.

As the (meth)acrylic resin, any appropriate (meth)acrylic resin can be adopted as long as the effects of the present invention are not impaired. Examples of the (meth)acrylic resin include poly(meth)acrylates such as methyl polymethacrylate, a methyl methacrylate-(meth)acrylic acid copolymer, a methyl methacrylate-(meth)acrylate copolymer, a methyl methacrylate-acrylate-(meth)acrylic acid copolymer, a methyl(meth)acrylate-styrene copolymer (MS resin, etc.), and a polymer having an alicyclic hydrocarbon group (e.g., a methyl methacrylate-cyclohexyl methacrylate copolymer, a methyl methacrylate-norbornyl(meth)acrylate copolymer). A preferred example includes C₁₋₆ alkyl poly(meth)acrylic acid such as polymethyl(meth)acrylate. A more preferred example includes a methyl methacrylate-based resin containing methyl methacrylate as a main component (50 to 100% by weight, preferably 70 to 100% by weight).

Specific examples of the (meth)acrylic resin include ACRYPET VH and ACRYPET VRL20A manufactured by Mitsubishi Rayon Co., Ltd., a (meth)acrylic resin having a ring structure in molecules described in JP 2004-70296 A, and a (meth)acrylic resin with high Tg obtained by intramolecular cross-linking or intramolecular cyclization reaction.

As the above (meth)acrylic resin, a (meth)acrylic resin having a lactone ring structure is particularly preferred because of high heat resistance, high transparency, and high mechanical strength.

Examples of the (meth)acrylic resin having the lactone ring structure include (meth)acrylic resins having a lactone ring structure described in JP 2000-230016 A, JP 2001-151814 A, JP 2002-120326 A, JP 2002-254544 A, and JP 2005-146084 A.

The mass average molecular weight (which may also be referred to as weight average molecular weight) of the (meth)acrylic resin having a lactone ring structure is preferably 1,000 to 2,000,000, more preferably 5,000 to 1,000,000, much more preferably 10,000 to 500,000, and particularly preferably 50,000 to 500,000.

The glass transition temperature (Tg) of the (meth)acrylic resin having the lactone ring structure is preferably 115° C. or higher, more preferably 125° C. or higher, still more preferably 130° C. or higher, particularly preferably 135° C. or higher, and most preferably 140° C. or higher. This is because the (meth)acrylic resin having a lactone ring structure and having Tg of 115° C. or higher can be excellent in durability. The upper limit value of the Tg of the (meth)acrylic resin having a lactone ring structure is not particularly limited, but is preferably 170° C. or lower from the viewpoint of formability and the like.

Each of the first protective film and the second protective film described above is preferably transparent and colorless. The thickness direction retardation Rth[590] of each of the first protective film and the second protective film is preferably −90 nm to +90 nm, more preferably −80 nm to +80 nm, and much more preferably −70 nm to +70 nm.

The side of the first protective film 14 described above opposite to the polarizer 11 can be subjected to hard coat treatment, antireflection treatment, sticking prevention treatment, antiglare treatment, or the like, if required.

As the thickness of each of the first protective film and the second protective film described above, any suitable thickness can be adopted. The thickness is preferably 200 μm or less, more preferably 1 to 200 μm, still more preferably 3 to 150 μm, or particularly preferably 5 to 100 μm.

A-5. Method of Manufacturing Laminated Optical Film

A method of manufacturing a laminated optical film of the present invention includes the step of laminating the above-mentioned retardation layer on one side of the above-mentioned polarizer. The polarizer 11 and the retardation layer 12 are typically laminated through an adhesive. The adhesive is specifically, for example, a polyvinyl alcohol-based adhesive. When the first protective film 14 is provided between the polarizer 11 and the retardation layer 12 as illustrated in FIG. 1, it is preferred that the polarizer 11 and the first protective film 14 be laminated in advance to produce a polarizing plate before the retardation layer 12 is laminated on the first protective film 14. The first protective film 14 and the retardation layer 12 are typically laminated through a pressure-sensitive adhesive. The pressure-sensitive adhesive is specifically, for example, an acrylic pressure-sensitive adhesive. It should be noted that the polarizer and the first protective film are typically laminated through an adhesive. The adhesive is, for example, a polyvinyl alcohol-based adhesive.

In one embodiment, the retardation layer 12 is laminated on the polarizer 11, the first protective film 14, or any other layer (such as the hard coat layer 13) in a state where the retardation layer 12 is formed on a substrate in advance so that the resultant may serve as a laminate. In this case, the retardation layer 12 formed on the substrate is transferred from the substrate onto the polarizer 11, the first protective film 14, or the other layer.

Any appropriate method may be adopted as a method of forming the above-mentioned retardation layer. For example, there may be exemplified a method involving subjecting the surface of the above-mentioned substrate to an alignment treatment and applying an application liquid containing the above-mentioned liquid crystal material to the surface to form the retardation layer. Any appropriate alignment treatment may be adopted as the alignment treatment. Specific examples of the treatment include a mechanical alignment treatment, a physical alignment treatment, and a chemical alignment treatment. Specific examples of the mechanical alignment treatment include a rubbing treatment and a stretching treatment. Specific examples of the physical alignment treatment include a magnetic field alignment treatment and an electric field alignment treatment. Specific examples of the chemical alignment treatment include an oblique deposition method and an optical alignment treatment. The rubbing treatment is preferred. The surface of the substrate may be directly subjected to the alignment treatment, or any appropriate alignment film (typically a silane coupling agent layer, a polyvinyl alcohol layer, or a polyimide layer) formed on the substrate may be subjected to the treatment. When the rubbing treatment is performed, it is preferred that the surface of the substrate be directly subjected to the treatment.

The alignment direction of the above-mentioned alignment treatment can be set in accordance with the above-mentioned desired angle α. Because the liquid crystal material can be aligned by performing the alignment treatment in accordance with the alignment direction of the substrate, the slow axis of the formed retardation layer is substantially identical to the alignment direction of the substrate. Therefore, for example, when the polarizer 11 (long shape) has an absorption axis in its lengthwise direction, the alignment treatment is performed in the direction at the angle α with respect to the lengthwise direction of the substrate (long shape). Details about the foregoing are described later. When the retardation layer is formed as described above, the polarizer 11 (polarizing plate) and the retardation layer 12 can be continuously laminated in a roll-to-roll fashion. As a result, the number of manufacturing steps can be markedly decreased.

The application liquid containing the above-mentioned liquid crystal material may be typically obtained by dissolving or dispersing the above-mentioned liquid crystal material in a solvent. Any appropriate solvent may be adopted as the solvent in accordance with, for example, the kind of the liquid crystal material. Specific example thereof includes: halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, mesitylene, methoxybenzene, and 1,2-dimethoxybenzene; ketone-based solvents such as acetone, methylethylketone (MEK), methylisobutylketone, cyclohexanone, cyclopentanone, 2-pyrolidone, and N-methyl-2-pyrolidone; ester-based solvents such as ethyl acetate, butyl acetate and propyl acetate; alcohol-based solvents such as t-butyl alcohol, glycerin, ethylene glycol, triethylene glycol, ethylene glycol monomethylether, diethylene glycol dimethylether, propylene glycol, dipropylene glycol, and 2-methyl-2,4-pentanediol; amide-based solvents such as dimethylformamide and dimethylacetoamide; nitrile-based solvents such as acetonitrile and butyronitrile; ether-based solvents such as diethylether, dibutylether, tetrahydroflan, and dioxane; carbon disulfide; ethyl cellosolve; butyl cellosolve; and ethyl cellosolve acetate. Of those, toluene, xylene, mesitylene, MEK, methyl isobutylketone, cyclohexanone, ethyl cellosolve, butyl cellosolve, ethyl acetate, butyl acetate, propyl acetate, and ethyl cellosolve acetate are preferred. Those solvents may be used alone or in combination.

The content of the liquid crystal material in the above-mentioned application liquid may be appropriately set in accordance with, for example, the kind of the liquid crystal material and a target thickness of the layer. The content of the liquid crystal material is preferably 5 to 50 wt %, more preferably 10 to 40 wt %, or most preferably 15 to 30 wt %.

The above-mentioned application liquid may further contain any appropriate additive as required. Specific examples of the additive include a polymerization initiator and a cross-linking agent. Each of them is particularly suitably used when a liquid crystal monomer is used as the liquid crystal material. Specific examples of the polymerization initiator include benzoylperoxide (BPO) and azobisisobutyronitrile (AIBN). Specific examples of the cross-linking agent include an isocyanate-based cross-linking agent, an epoxy-based cross-linking agent, and a metal chelate cross-linking agent. They maybe used alone or in combination. Further, specific examples of the additive include an antioxidant, a modifier, a surfactant, a dye, a pigment, a color protection agent, and a UV screening agent. They may be used alone or in combination. Examples of the antioxidant include a phenol-based compound, an amine-based compound, an organic sulfur-based compound, and a phosphine-based compound. Examples of the modifier include glycols, silicones, and alcohols. The surfactant is, for example, used for smoothing the surface of an optical film. Specific examples of the surfactant include silicone-based, acrylic, and fluorine-based surfactants. The UV screening agent is as such described in Section A-2.

The content of the above-mentioned UV screening agent may be appropriately set. The content is preferably 0.01 to 0.1 part by weight or more preferably 0.03 to 0.07 part by weight with respect to 100 parts by weight of the above-mentioned liquid crystal material.

Any appropriate method may be adopted as an application method for the application liquid. Specific examples thereof include roll coating, spin coating, wire bar coating, dip coating, extrusion, curtain coating, and spray coating. An application amount of the application liquid may be appropriately set depending on, for example, a concentration of the application liquid and a target thickness of the layer. For example, when the concentration of the liquid crystal material is 20 wt % in the application liquid, the application amount is preferably 0.03 to 0.17 ml, more preferably 0.05 to 0.15 ml, and most preferably 0.08 to 0.12 ml per an area of the transparent protective film (100 cm²).

Next, the above-mentioned liquid crystal material is aligned in accordance with the alignment direction of the surface of the above-mentioned substrate. The liquid crystal material is aligned by performing a treatment at the temperature at which the liquid crystal material to be used shows a liquid crystal phase. When such temperature treatment is performed, the liquid crystal material is brought into a liquid crystal state, and the liquid crystal material is aligned in accordance with the alignment direction of the surface of the substrate. As a result, birefringence arises in the layer formed by application (applied layer), and hence the retardation layer is formed.

The temperature of the above-mentioned temperature treatment may be set appropriately depending upon the kind of the liquid crystal material. The temperature is preferably 40 to 120° C., more preferably 50 to 100° C., and most preferably 60 to 90° C. Further, the treatment time of the temperature treatment is preferably 30 seconds or more, more preferably 1 minute or more, particularly preferably 2 minutes or more, or most preferably 4 minutes or more. In the case where the treatment time is less than 30 seconds, a liquid crystal material may not be brought into a sufficient liquid crystal state. On the other hand, the treatment time is preferably 10 minutes or less, more preferably 8 minutes or less, or most preferably 7 minutes or less. When the treatment time exceeds 10 minutes, an additive may be sublimated.

If the liquid crystal monomer is used as the liquid crystal material, it is preferred that the applied layer be further subjected to a polymerization treatment or cross-linking treatment. Performing the polymerization treatment causes the liquid crystal monomer to polymerize and causes the liquid crystal monomer to be fixed as a repeating unit of a polymer molecule. Performing the cross-linking treatment causes the liquid crystal monomer to form a three-dimensional network structure, and causes the liquid crystal monomer to be fixed as part of a cross-linked structure. As a result, the alignment state of the liquid crystal material is fixed. It should be noted that the polymer or three-dimensional network structure formed by the polymerization or cross-linking of the liquid crystal monomer is “non-liquid crystalline”, and hence, the formed retardation layer does not undergo any transition to a liquid crystal phase, a glass phase, or a crystal phase owing to, for example, a temperature change peculiar to a liquid crystal molecule. A specific procedure of the polymerization treatment or cross-linking treatment may be appropriately selected depending on the kind of a polymerization initiator or cross-linking agent to be used. For example, when a photopolymerization initiator or a photocross-linking agent is used, irradiation with light has only to be performed, and when a UV polymerization initiator or a UV cross-linking agent is used, irradiation with UV light has only to be performed. The time period for irradiation with light or UV light, the irradiation intensity of light or UV light, the total quantity of light or UV light, and the like may be appropriately set depending on the kind of the liquid crystal material, the kind of the substrate, the kind of the alignment treatment, desired characteristics for the retardation layer, and the like.

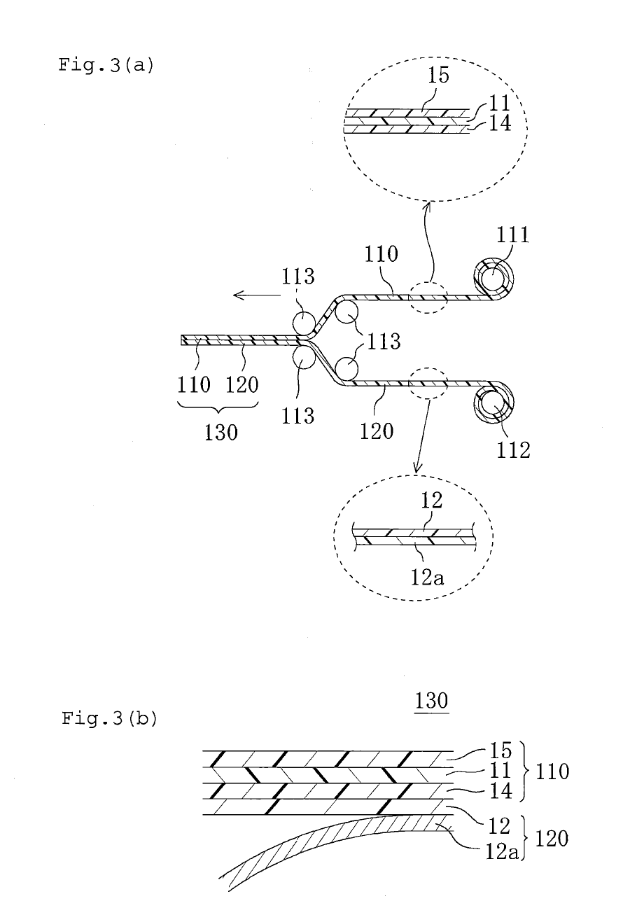

FIG. 3 each illustrate one step in an example of the method of manufacturing a laminated optical film of the present invention. As illustrated in FIG. 3(a), a polarizing plate 110 (a laminate of the first protective film 14, the polarizer 11, and the second protective film 15) and a laminate 120 obtained by forming the retardation layer 12 by application on a substrate 12a are delivered in the direction indicated by an arrow, and are then attached to each other with the above-mentioned adhesive (not shown) in a state where their lengthwise directions are brought into line with each other. When the retardation layer and the polarizer (polarizing plate) are continuously laminated while being conveyed as described above (roll-to-roll), the number of manufacturing steps can be markedly decreased. In addition, foreign matter can be prevented from intruding between the retardation layer and the polarizer (polarizing plate), and hence a laminated optical film that can be excellent in visibility can be provided. Finally, the substrate 12a is removed from an attached laminate 130 as illustrated in FIG. 3(b). It should be noted that, in FIG. 3(a), reference numerals 111 and 112 each represent a roll around which a film that forms each layer is wound, and reference numeral 113 represents a guide roll for attaching the films.

B. Liquid Crystal Panel

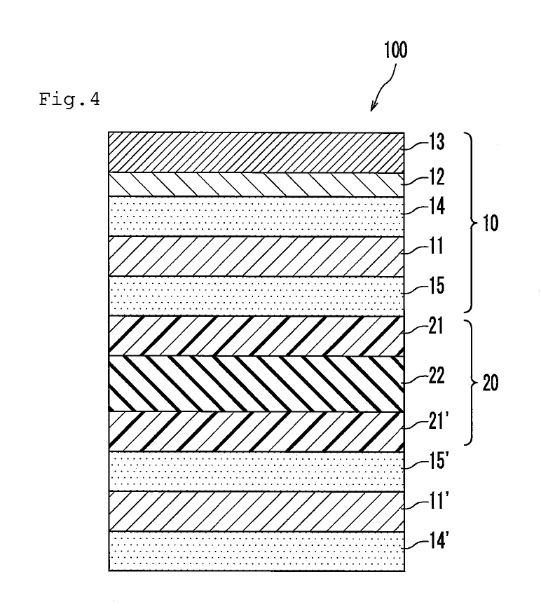

A liquid crystal panel of the present invention includes the above-mentioned laminated optical film. FIG. 4 is a schematic sectional view of a liquid crystal panel according to a preferred embodiment of the present invention. A liquid crystal panel 100 includes a liquid crystal cell 20, the laminated optical film 10 arranged on the viewer side of the liquid crystal cell 20, and a polarizer 11′ arranged on the backlight side of the liquid crystal cell 20. The laminated optical film 10 is arranged so that its retardation layer 12 may be closer to the viewer side than the polarizer 11 is. Although not illustrated, the liquid crystal panel 100 may include any other appropriate retardation layer arranged between the liquid crystal cell 20 and the laminated optical film 10 and/or between the liquid crystal cell and the polarizer 11′. In addition, the liquid crystal panel 100 may include a third protective film 14′ arranged on the backlight side of the polarizer 11′ and/or a fourth protective film 15′ arranged between the liquid crystal cell 20 and the polarizer 11′. A film similar to the above-mentioned first protective film 14 may be adopted as the third protective film 14′. A film similar to the above-mentioned second protective film may be adopted as the fourth protective film 15′.

As a matter of practicality, any appropriate pressure-sensitive adhesive layer or adhesive layer is provided between members that form the liquid crystal panel of the present invention.

B-1. Liquid Crystal Cell

The liquid crystal cell 20 includes a pair of glass substrates 21, 21′ and a liquid crystal layer 22 as a display medium placed between the substrates 21, 21′. On one substrate (color filter substrate), a color filter and a black matrix (both not shown) are provided. On the other substrate (active matrix substrate), switching elements (typically, TFT) for controlling the electrooptical characteristics of liquid crystal; scanning lines that provide a gate signal to the switching elements; signal lines that give a source signal thereto and pixel electrode are provided (all not shown). The color filter may be provided on the active matrix substrate. The gap (cell gap) between the substrates 21 and 21′ is controlled with spacers (not shown). On each side of the substrates 21 and 21′, which is in contact with the liquid crystal layer 22, an alignment film (not shown) made of, for example, polyimide is provided.

As the driving mode of the liquid crystal cell 20, any appropriate driving mode can be adopted. Specific examples of the driving mode include a super twisted nematic (STN) mode, a twisted nematic (TN) mode, an in-plane switching (IPS) mode, a vertical aligned (VA) mode, an optically aligned birefringence (OCB) mode, a hybrid aligned nematic (HAN) mode, an axially symmetric aligned microcell (ASM) mode, and an electrically controlled birefringence (ECB) mode.

C. Liquid Crystal Display Apparatus

A liquid crystal display apparatus of the present invention includes the above-mentioned liquid crystal panel. The liquid crystal panel is arranged so that the above-mentioned laminated optical film may be on a viewer side.

### EXAMPLES

Hereinafter, the present invention is described specifically by way of examples. However, the present invention is not limited to those examples. It should be noted that the measurement methods of the retardation value of respective layers (films) are as follows.

### (Measurement of Retardation Value)

A retardation value was automatically measured using KOBRA-WPR manufactured by Oji Scientific Instruments. The measurement wavelength was 590 nm and the measurement temperature was 23° C.

### Example 1

### (Production of Retardation Layer)

A polyvinyl alcohol film (having a thickness of 0.1 μm) was formed on the surface of a substrate (TAC film having a thickness of 40 μm). After that, the surface of the polyvinyl alcohol film was subjected to a rubbing treatment with a rubbing cloth in the direction at 45° with respect to the lengthwise direction of the substrate. Thus, an aligned substrate was produced.

Next, 10 g of a polymerizable liquid crystal showing a nematic liquid crystal phase (available from BASF under the trade name of Paliocolor LC242) and 0.5 g of a photopolymerization initiator for the polymerizable liquid crystal (available from Ciba Specialty Chemicals Inc. under the trade name of IRGACURE 907 and containing 1% of a benzotriazole-based UV absorbing agent) were dissolved in 40 g of toluene. Thus, an application liquid was prepared. Then, the application liquid was applied to the surface of the aligned substrate obtained in the foregoing with a bar coater. After that, the liquid was dried by heating at 90° C. for 2 minutes so that the liquid crystal might be aligned. A liquid crystal layer thus formed was irradiated with light at 20 mJ/cm² with a metal halide lamp so as to be cured. Thus, a retardation layer was formed on the substrate. The resultant retardation layer had a thickness of 1.4 μm and an in-plane retardation value Re[590] of 142.1 nm.

(Formation of Hard Coat Layer)

0.5 wt % of a leveling agent was added to an acrylic resin raw material (available from DAINIPPON INK AND CHEMICALS, INCORPORATED under the trade name of GRANDIC PC1071). Further, the mixture was diluted with ethyl acetate so that a solid content might be 50 wt %. Thus, an application solution for forming a hard coat layer was prepared. It should be noted that the leveling agent is a copolymer obtained by copolymerizing dimethylsiloxane, hydroxypropylsiloxane, 6-isocyanatehexyl isocyanurate, and aliphatic polyester at a molar ratio of 6.3:1.0:2.2:1.0.

Next, the obtained application solution was applied to the surface of a TAC film (available from KONICA MINOLTA HOLDINGS INC. under the trade name of KC4UY-TAC and having a thickness of 40 μm) with a bar coater, followed by heating at 100° C. for one minute. Then, an applied film was dried. After that, the film was irradiated with UV light at an integrated light quantity of 300 mJ/cm² with a metal halide lamp, to thereby cure the applied film. Thus, a hard coat layer (having a thickness of 3 μm) was formed.

(Production of Laminated Optical Film)

The retardation layer obtained above was laminated on the TAC film side of the TAC film on which the hard coat layer was formed through a polyester-based adhesive (available from Takeda Pharmaceutical Co., Ltd. under the trade name of TAKENATE A310/TAKELAC A-3, using ethyl acetate as a solvent, and having a thickness of 4 μm), and then the substrate was removed.

After that, a polarizing plate (available from Nitto Denko Corporation under the trade name of TEG1465DU and having a thickness of 128 μm) was laminated on the surface of the retardation layer through an acrylic pressure-sensitive adhesive (having a thickness of 12 μm). In this case, the lamination was performed so that an angle formed between the absorption axis of the polarizer and the slow axis of the retardation layer might be 45°.

A laminated optical film thus obtained had a thickness of 189 μm.

### Example 2

### (Production of Polarizer)

A polyvinyl alcohol film having a thickness of 80 μm (with an average polymerization degree of 2400 and a saponification degree of 99.9%) was swollen by being immersed in pure water at 30° C. Next, the film was dyed and stretched by a factor of 2.5 while being immersed in a dyeing bath blended with iodine and potassium iodide at 30° C. for 60 seconds. Next, the resultant was stretched by a factor of 2.3 while being immersed in an aqueous solution of boric acid at 40° C. for 60 seconds. Further, the resultant was immersed in an aqueous solution having a potassium iodide concentration of 5% at 30° C. for 5 seconds. After that, the resultant was dried at 50° C. for 4 minutes. As a result, a polarizer (having a thickness of 26 μm) was obtained.

(Production of Laminated Optical Film)

The retardation layer obtained in Example 1 was laminated on the TAC film side of the TAC film on which the hard coat layer obtained in Example 1 was formed through a polyester-based adhesive (available from Takeda Pharmaceutical Co., Ltd. under the trade name of TAKENATE A310/TAKELAC A-3, using ethyl acetate as a solvent, and having a thickness of 4 μm), and then the substrate was removed.

After that, the polarizer obtained in the foregoing was laminated on the surface of the retardation layer through a polyvinyl alcohol-based adhesive (available from The Nippon Synthetic Chemical Industry Co., Ltd. under the trade name of 2200 and having a thickness of 200 nm). In this case, the lamination was performed so that an angle formed between the absorption axis of the polarizer and the slow axis of the retardation layer might be 45°.

After that, a TAC film (available from KONICA MINOLTA HOLDINGS, INC. under the trade name of KC4UY-TAC and having a thickness of 40 μm) was laminated on the surface of the polarizer through a polyvinyl alcohol-based adhesive (available from The Nippon Synthetic Chemical Industry Co., Ltd. under the trade name of Z200 and having a thickness of 200 nm). Further, an acrylic pressure-sensitive adhesive (having a thickness of 20 μm) was laminated.

A laminated optical film thus obtained had a thickness of 137 μm.

### Comparative Example 1

### (Production of Laminated Optical Film)

A laminated optical film was obtained in the same manner as in Example 1 except that the following retardation film was used instead of the retardation layer.

A laminated optical film thus obtained had a thickness of 221 μm.

### [Retardation Film]

A long norbornene-based resin film (available from Zeon Corporation under the trade name of Zeonor and having a thickness of 40 μm and an optical elastic coefficient of 3.10×10⁻¹² m²/N) was subjected to uniaxial stretching by a factor of 1.52 at 140° C., to thereby produce a long film. The obtained film was cut into a predetermined size. The thickness of the film was 33 μm, the in-plane retardation value Re[590] thereof was 140 nm, and the thickness direction retardation Rth[590] thereof was 140 nm.

### Reference Example 1

### (Production of Laminated Optical Film)

A laminated optical film was obtained in the same manner as in Example 1 except that the retardation layer was not laminated.

The laminated optical films of Examples 1 and 2 of the present invention were much thinner than the laminated optical film of Comparative Example 1. As a result, the laminated optical film of the present invention can contribute to thinning of each of a liquid crystal panel and a liquid crystal display apparatus.

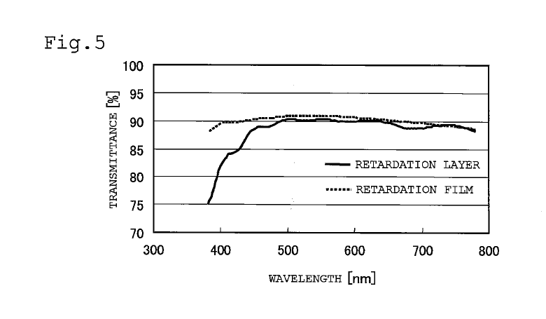

Transmittance measurement was performed for the retardation layer used in Example 1 of the present invention and the retardation film used in Comparative Example 1 with an UV and visible spectrophotometer (available from JASCO Corporation under the product name of V-570). FIG. 5 illustrates the results. As is apparent from FIG. 5, the transmittance of the retardation layer of Example 1 significantly reduces at a wavelength boundary of around 400 nm as compared to the retardation film of Comparative Example 1. Therefore, it can be said that the retardation layer of Example 1 has an excellent UV screening (absorbing) ability.

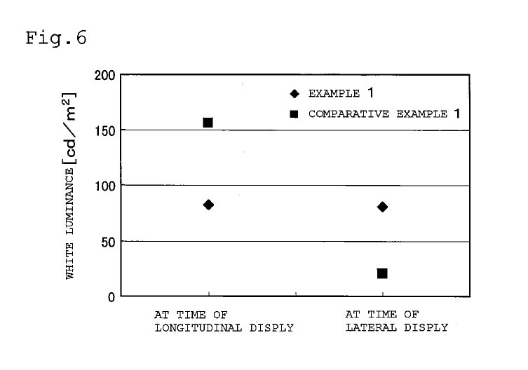

A liquid crystal cell was removed from a cellular phone (911SH of SOFTBANK CORP. manufactured by Sharp Corporation), and the laminated optical film obtained in Example 1 or Reference Example 1 was attached to the viewer side of the liquid crystal cell with a pressure-sensitive adhesive. Further, a polarizing plate (available from Nitto Denko Corporation under the trade name of TEG1465DU) was attached to the surface of the laminated optical film with a pressure-sensitive adhesive. In this case, the attachment was performed so that an angle formed between the absorption axis of the polarizer of the polarizing plate and the absorption axis of the polarizer of the laminated optical film might be 90°. A white luminance when the display screen of the cellular phone thus obtained was rotated clockwise by 90° (lateral display) and a white luminance when the display screen was not rotated (normal state, longitudinal display) were measured. FIG. 6 illustrates the results of the measurement.

As illustrated in FIG. 6, when the laminated optical film of Example 1 was mounted, there was nearly no difference between the white luminance at the time of the longitudinal display and the white luminance at the time of the lateral display. On the other hand, when the laminated optical film of Reference Example 1 was mounted, there was a significant difference between the white luminance at the time of the longitudinal display and the white luminance at the time of the lateral display. The foregoing shows that Example 1 is excellent in visibility even when the display screen is viewed through a polarizing lens such as a polarizing sunglass.

### INDUSTRIAL APPLICABILITY

The laminated optical film, liquid crystal panel, and liquid crystal display apparatus of the present invention may each be used in any appropriate application. As typical cases, they may suitably find use in applications including: portable equipment such as a cellular phone, a portable game machine, a watch, a digital camera, and a personal digital assistant (PDA); on-vehicle equipment such as a back monitor, a monitor for a car navigation system, and a car audio; and display equipment such as a monitor for information for shops.

1. A laminated optical film used in a liquid crystal display apparatus and arranged on a viewer side of a liquid crystal cell, the laminated optical film comprising:
a polarizer; and
a retardation layer which
is arranged on one side of the polarizer,
has a refractive index ellipsoid showing a relationship of nx>ny=nz, and
has an in-plane retardation value Re[590] of 90 to 190 nm,
wherein:
an angle formed between an absorption axis of the polarizer and a slow axis of the retardation layer is 5 to 85°;
the retardation layer is formed of a liquid crystal material; and
the retardation layer is arranged to be closer to the viewer side than the polarizer is.

2. A laminated optical film according to claim 1, further comprising a hard coat layer arranged on a side of the retardation layer opposite to the polarizer.

3. A laminated optical film according to claim 1, further comprising a first protective film arranged between the polarizer and the retardation layer.

4. A laminated optical film according to claim 1, further comprising a first protective film arranged on a side of the retardation layer opposite to the polarizer.

5. A laminated optical film according to claim 1, wherein the angle formed between the absorption axis of the polarizer and the slow axis of the retardation layer is 40 to 50°.

6. A laminated optical film according to claim 1, wherein the retardation layer comprises a cured layer of the liquid crystal material.

7. A laminated optical film according to claim 1, wherein the retardation layer contains a UV screening agent.

8. A liquid crystal panel comprising the laminated optical film according to claim 1.

9. A liquid crystal display apparatus comprising the liquid crystal panel according to claim 8.

10. A method of manufacturing a laminated optical film used in a liquid crystal display apparatus and arranged on a viewer side of a liquid crystal cell, the method comprising the steps of:
subjecting a surface of a long-shaped substrate to an alignment treatment;
applying an application liquid containing a liquid crystal material to the surface of the substrate to form a retardation layer which has a refractive index ellipsoid showing a relationship of nx>ny=nz and which has an in-plane retardation value Re[590] of 90 to 190 nm; and
laminating a long-shaped polarizer having an absorption axis in its lengthwise direction and the retardation layer so that the lengthwise direction of the polarizer and a lengthwise direction of the retardation layer are brought into line with each other while conveying each of the polarizer and the retardation layer in the lengthwise direction,
wherein:
the lamination is performed so that an angle formed between a slow axis of the retardation layer and the absorption axis of the polarizer is 5 to 85°; and
the retardation layer is arranged to be closer to the viewer side than the polarizer is.
